(19) United States
(12) Patent Application Publication
(10) Pub. No.: US 2014/0183309 A1
(43) Pub. Date: Jul. 3, 2014

(54) Holder

(71) Applicant: Elizabeth Ann Pasho, Milwaukee, WI (US)

(72) Inventor: Elizabeth Ann Pasho, Milwaukee, WI (US)

(21) Appl. No.: 13/730,072

(22) Filed: Dec. 28, 2012

(51) Int. Cl. F16M 13/02

(52) U.S. Cl. CPC F16M 13/02
USPC 248/205.1; 248/315; 29/428

(57) ABSTRACT

A holder is provided. In one embodiment, the holder includes a holding portion, a hinge portion and an engagement portion. In one embodiment, the engagement portion is configured to couple to an object in an environment. In one embodiment, the engagement portion is pivotally displaceable relative to the holding portion between a first configuration and a second storage configuration.

### BACKGROUND OF THE INVENTION

Embodiments of the present invention relate generally to the field of holders, and more specifically to portable cup holders. Various types of holders for containers, such as, e.g., containers for beverages, exist.

### SUMMARY OF THE INVENTION

One embodiment of the invention relates to a holder. The holder includes a holding portion including a ring portion. The ring portion includes an inner surface defining an aperture. The holder includes a hinge portion. The holder includes an engagement portion. The engagement portion is pivotally displaceable relative to the holding portion between a first configuration in which the holder is configured to receive a first object, the inner surface being configured to engage the first object received within the aperture and a second configuration. The engagement portion extends between a first end proximate the hinge portion and a second end distal from the hinge portion. The engagement portion defines a slot for receiving a second object in an environment by which the holder is configured to be supported. The engagement portion defines a gap distal from the hinge portion through which the second object is configured to be received into the aperture.

Another embodiment of the invention relates to a holder. The holder includes a ring portion. The ring portion is configured to engage and support a container. The holder includes an engagement portion pivotally coupled to the holding portion. The engagement portion is pivotable between a first configuration wherein the holding portion is configured to support the container and a second configuration. The engagement portion extends generally downwardly away from the ring portion in the first configuration. The engagement portion is inhibited from pivotal movement relative to the ring in one direction in the first configuration.

Another embodiment of the invention relates to a method of using a holder. The holder includes a holding portion including a ring portion configured to engage and support a container. The engagement portion is pivotally coupled to the holding portion. The engagement portion is pivotable between a first configuration wherein the holding portion is configured to support a container and a second configuration. The engagement portion extends generally downwardly away from the ring portion in the first configuration. The method includes the step of pivotally displacing the engagement portion to the first configuration. The method includes the step of coupling the engagement portion to a support. The method includes the step of locating a container in the holding portion. The method includes the step of removing the container from the holding portion. The method includes the step of uncoupling the engagement portion from the support. The method includes the step of pivotally displacing the engagement portion to the second configuration.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of an embodiment of a holder coupled to an exemplary object in an environment.

FIG. 2 is a perspective view of the holder of FIG. 1 illustrating actuation of a mounting portion of the holder from a first configuration to a second configuration.

FIG. 3 is a side view, with the opposite side view being a mirror image thereof, of the holder of FIGS. 1 and 2 in a first configuration.

FIG. 4 is an exploded view of the holder of FIGS. 1-3.

FIG. 5 is an exploded of the holder of FIGS. 1-4 rotated 90 degrees about a vertical axis relative to FIG. 4.

FIG. 6 is an exploded rear view of the holder of FIGS. 1-5 illustrating relative dimensions of portions of the holder.

FIG. 7 is an assembled rear view of an embodiment of a holder in a first configuration.

FIG. 8 is an assembled front view of an embodiment of a holder in a first configuration.

FIG. 9 is a top view of an embodiment of a holder in a first configuration.

FIG. 10 is a bottom view of an embodiment of a holder in a first configuration.

FIG. 11 is a perspective view of an embodiment of a holder in a second configuration.

FIG. 12 is a side view, with the opposite side view being a mirror image thereof.

FIG. 13 is a rear view of an embodiment of a holder in a second configuration.

FIG. 14 is a front view of an embodiment of a holder in a second configuration.

FIG. 15 is a top view of an embodiment of a holder in a second configuration.

FIG. 16 is a bottom view of an embodiment of a holder in a second configuration.

FIG. 17 is a perspective view of another embodiment of a holder in a first configuration.

FIG. 18 is a perspective view of another embodiment of a holder in a second configuration.

FIG. 19 is a rear view of another embodiment of a holder in a first configuration.

FIG. 20 is a front view of another embodiment of a holder in a first configuration.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring generally to the figures, embodiments of holders are illustrated. In one embodiment, a holder for a container, such as, for example, a container (e.g., glass, mug, paper cup, plastic cup, Styrofoam cup, can, any other suitable disposable or non-disposable open-topped or closed-topped container, etc.) for a beverage, food, or any other suitable type of material is provided.

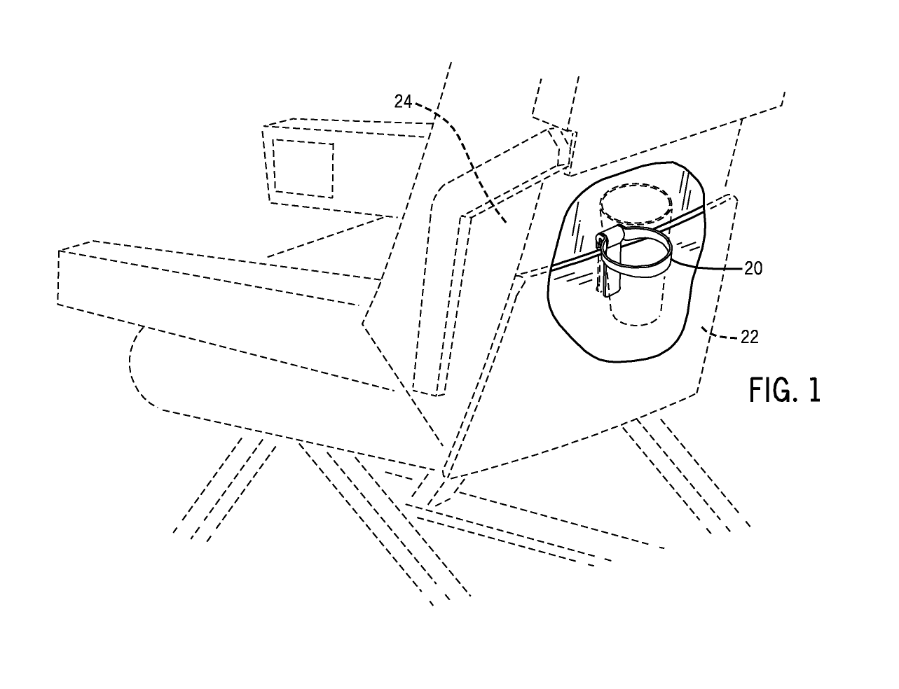

Referring to FIG. 1, an embodiment of a holder 20 is illustrated. The holder 20 is coupled to and supported on a pocket 22 of a seat 24 (e.g., bus seat, airplane seat, etc.) The holder 20 is configured when coupled to and supported by the pocket 22 to receive and support a container.

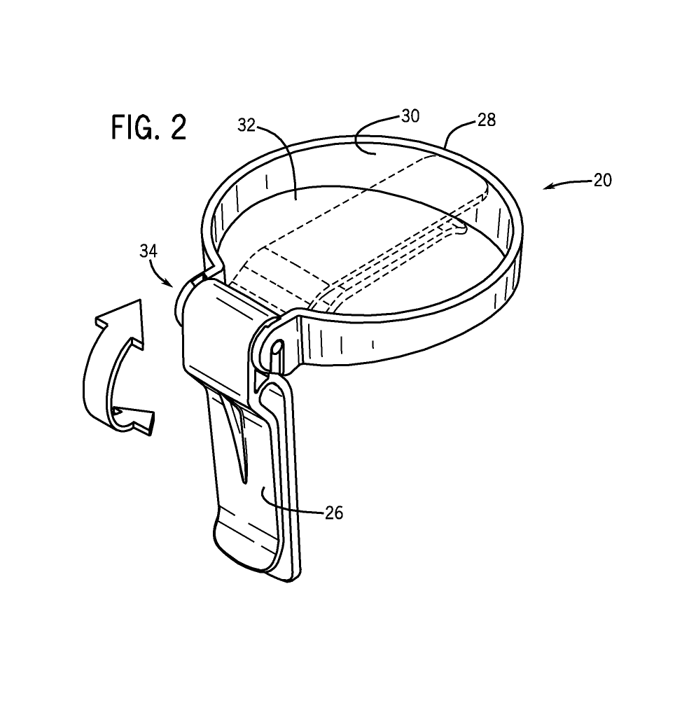

With reference to FIG. 2, in one embodiment, the holder 20 includes an engagement portion configured to couple to an object such as a pocket to support the holder 20, illustrated in FIG. 2 as clip 26, and a holding portion configured to hold a container, illustrated in FIG. 2 as ring portion 28. The ring portion 28 has an inner surface 30 that defines an aperture 32.

In FIG. 2 the holder 20 is illustrated in a first configuration in which the holder 20 is configured to be supported and to support a container, and a second configuration, illustrated in dashed lines, in which the clip 26 may be located within the aperture 32. The clip 26 is pivotally coupled to the ring portion 28 by a hinge portion 34. The clip 26 may be pivotally displaced between a first configuration, shown in FIG. 2 in solid lines, and a second configuration, shown in FIG. 2 in dashed lines.

With the clip 26 in the first configuration, the holder 20 is configured to be supported and to receive and support a container in the aperture 32. In the second configuration, the clip 26 is located within the aperture 32. Thus, in one embodiment, the holder 26 may be compact and suitable for transporting with the clip 26 in the second configuration.

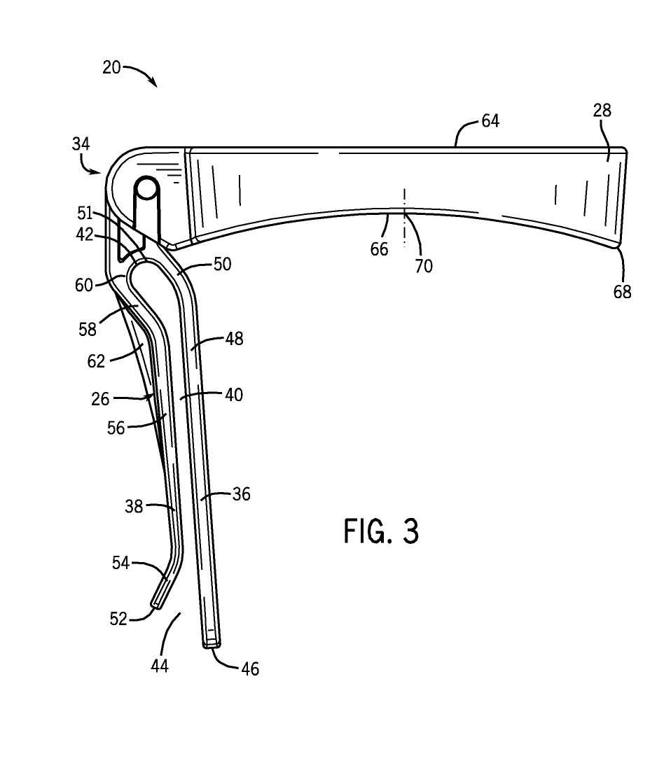

FIG. 3 is a side view of the holder 20 in the first configuration. The clip 26 includes a first leg 36 and a second leg 38. The first and second legs 36 and 38 are spaced apart and define a slot 40 between them extending from a junction 42 joining the first and second legs 36 and 38 proximate the hinge portion 34 to a gap 44 defined between the ends of the legs 36 and 38 distal from the hinge portion 34. The clip 26 is configured to receive a support, such as a pocket, through the gap 44 and into the slot 40.

The first leg 36 extends from a first end 46 to the junction 42 and includes a portion 48 extending from the first end 46 to a projecting portion 50. The portion 48 is generally flat, of uniform thickness, and extends along a plane between the first end 46 and the end of the projecting portion 50. The projecting portion 50 projects angularly from the portion 48 to a curved portion 51. The curved portion 51 extends generally arcuately from the projecting portion 50 to the junction 42.

The second leg 38 extends from a first end 52 to the junction 42 and includes a projecting portion 54 projecting angularly outwardly away from the first leg 36. The second leg 38 also includes a portion 56 extending generally parallel to the portion 48 of the first leg 36 from the projecting portion 54 toward the hinge portion 34. The portion 56 extends generally along a plane between the projecting portion 54 and an end of an angularly projecting portion 58. The angularly projecting portion 58 extends from the portion 56 to a curved portion 60. The curved portion 60 extends generally arcuately from the angularly projecting portion 58 to the junction 42.

The second leg 38 also includes a projecting wall 62 projecting from the second leg 38 away from the first leg. The wall 62 extends away from the first leg 36 generally perpendicularly to the portion 56. The wall 62 extends from the portion 56 to the angularly projecting portion 58 and varies in height from a minimum proximate the portion 56 to a maximum proximate the junction between the portion 56 and the angularly projecting portion 58 to a minimum proximate the junction between the angularly projecting portion 58 and the curved portion 60.

With further reference to FIG. 3, the upper edge 64 of the ring portion 28 is generally lies in the same plane over the entirety of the ring portion 28. The lower edge 66 of the ring portion 28 is curved and curves upwardly from the first end 68 of the ring portion 28 distal from the hinge portion 34 to a midpoint 70. The lower edge 66 curves downwardly from the midpoint 70 towards the hinge portion 34. The lower edge 66 is shaped generally concave relative to the upper edge 64.

As is illustrated in FIG. 3, in one embodiment when the clip 26 is in the first configuration, the clip 26 extends generally downwardly from the ring portion 28. The clip 26 is configured to receive a support, such as a pocket upwardly through the gap 44 and into the slot 40 to support the holder 20. In one embodiment, the shape of the legs 36 and 38 is configured such that the support is retained in the slot 40 and the holder 20 is supported with the ring portion 28 generally above at least a portion of the clip 26.

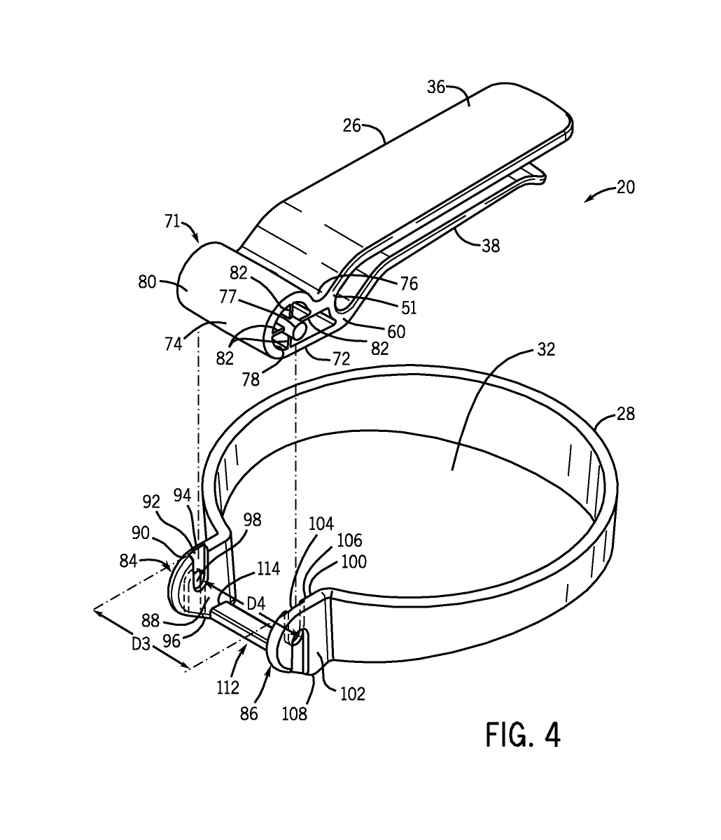

FIG. 4 illustrates a perspective exploded view of an embodiment of a holder 20. The clip 26 includes a coupling portion 71 configured to couple the clip 26 to the ring portion 28. The coupling portion 71 includes a planar segment 72, a rounded portion 74, and a recessed portion 76. The planar segment 72 extends from the curved portion 60 of the second leg 38 away from the second leg 38 to the rounded portion 74. The rounded portion 74 extends from the planar segment 72 and generally around hub 77. The rounded portion 74 extends from the planar segment 72 to the recessed portion 76. The recessed portion 76 defines a recess between the rounded portion 74 and the first leg 36 and extends from the rounded portion 74 to the curved portion 51 of the first leg 26.

The coupling portion 71 has an inner surface 78 and an outer surface 80. The inner surface 78 defines an aperture. Extending radially inwardly into the aperture from the inner surface 78 are a plurality of spokes 82. The spokes 82 project from the inner surface 78 to the hub 77. In one embodiment, the hub 77 is located at the radial center of the rounded portion 74.

With further reference to FIG. 4, extending from the ring portion 28 are a first flange 84 and a second flange 86. The first and second flanges 84 and 86 extend generally radially away from the aperture 32. In the illustrated embodiment, the first flange 84 and the second flange 86 extend toward one another from their axial top periphery to their axial bottom periphery (e.g., the distance between the first flange 84 and the second flange 86 is greater proximate their axial top portions than the distance between the first flange 84 and the second flange 86 proximate their axial bottom portions). In another embodiment, the first flange 84 and the second flange 86 are generally parallel (e.g., the distance between the first flange 84 and the second flange 86 is the same proximate their axial top portions and proximate their axial bottom portions).

The first flange 84 has an inner surface 88 and an outer surface 90. A track 92 is defined in the inner surface 88. The track 92 extends from the upper end 94 of the first flange 84 toward the lower end 96 of the first flange 84. The track 92 terminates at a rounded recessed portion 98 distal from the upper end 94 of the first flange 84.

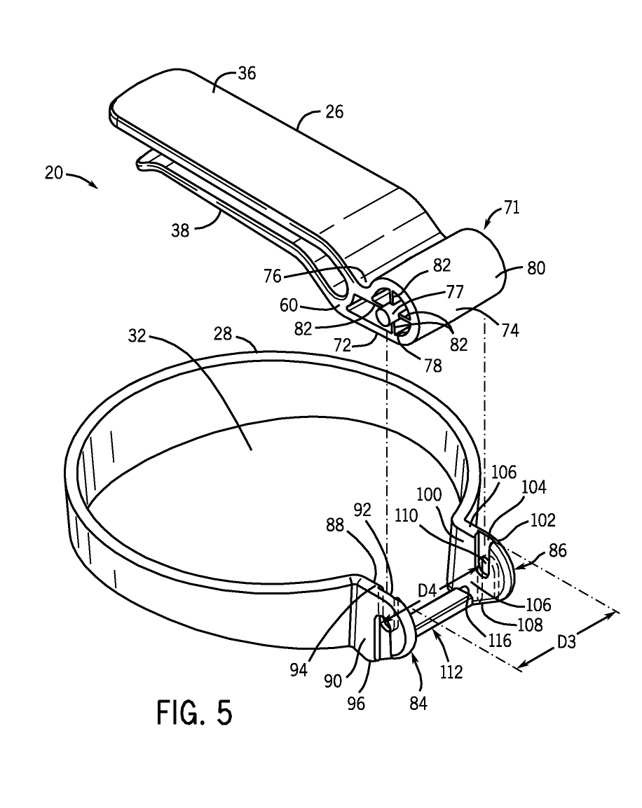

With reference to FIG. 5, the second flange 86 includes an inner surface 100 and an outer surface 102. A track 104 is defined in the inner surface 100. The track 104 extends from the upper end 106 of the second flange 86 toward the lower end 108 of the second flange 86. The track 104 extends generally corresponding to and across from the track 92 of the first flange 84 (see FIG. 4). The track 104 terminates at a rounded recessed portion 110 distal from the upper end 106 of the second flange 86. The round recessed portions 98 and 110 are generally aligned.

With reference to FIGS. 4 and 5, extending between the flanges 84 and 86 is a stop, illustrated as bar 112. The bar 112 extends from a first end 114 (see FIG. 4) proximate the lower end 96 of the first flange 84 below the rounded recessed portion 98 to a second end 116 (see FIG. 5) proximate the lower end 108 of the second flange 86 below the rounded recessed portion 110. The bar 112 is configured such that when the clip 26 is in the first configuration, the bar 112 is located in the recess against the recessed portion 76 of the coupling portion 71 of the clip 26, preventing further displacement of the clip 26 in a first direction relative to the ring portion 28. The bar 112 is also configured such that when the clip 26 is in the second configuration, the bar 112 is located against the planar segment 72, preventing further displacement of the clip 26 in a second direction opposite the first direction relative to the ring portion 28.

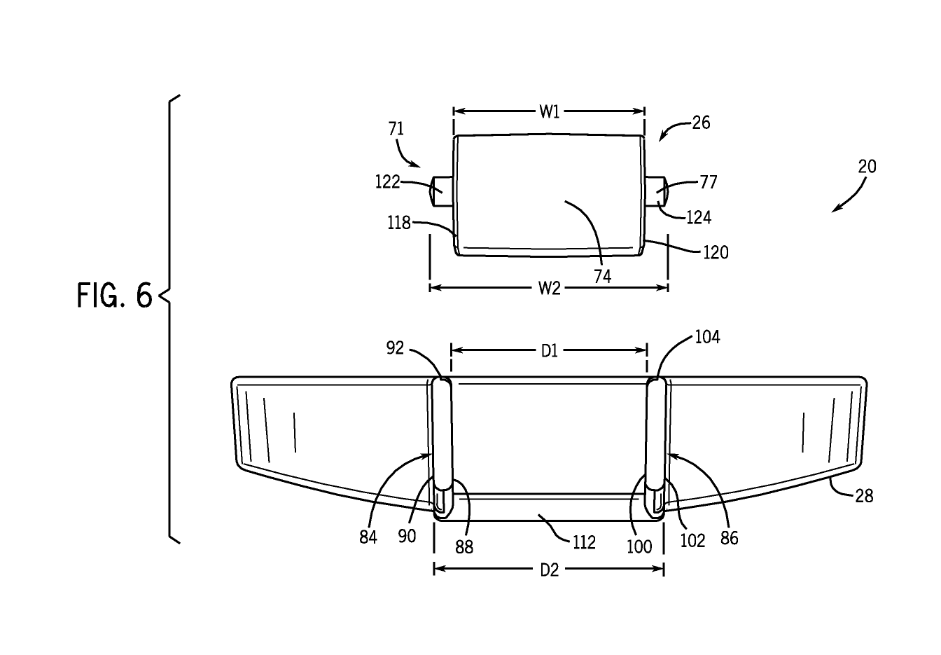

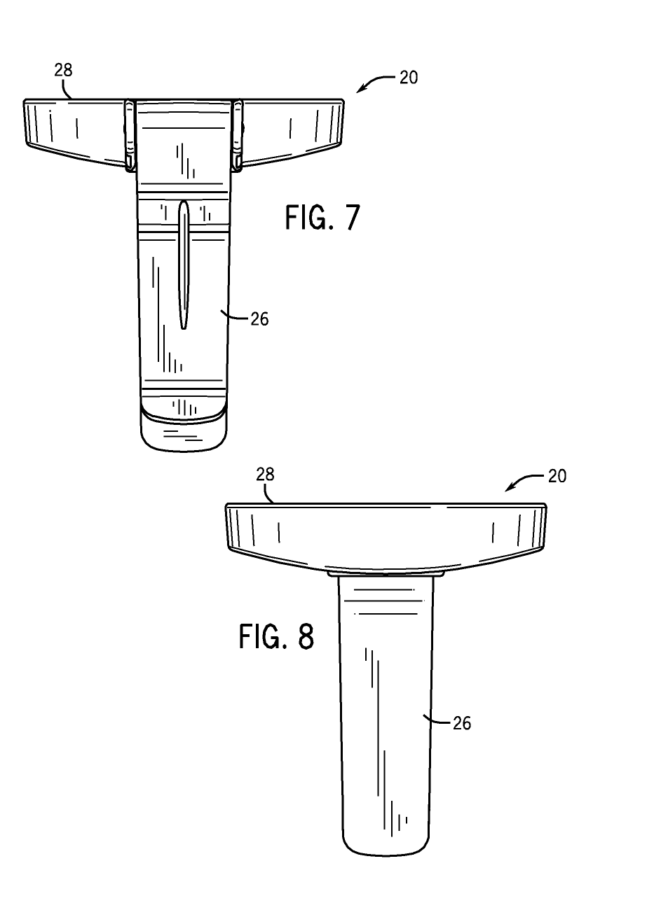

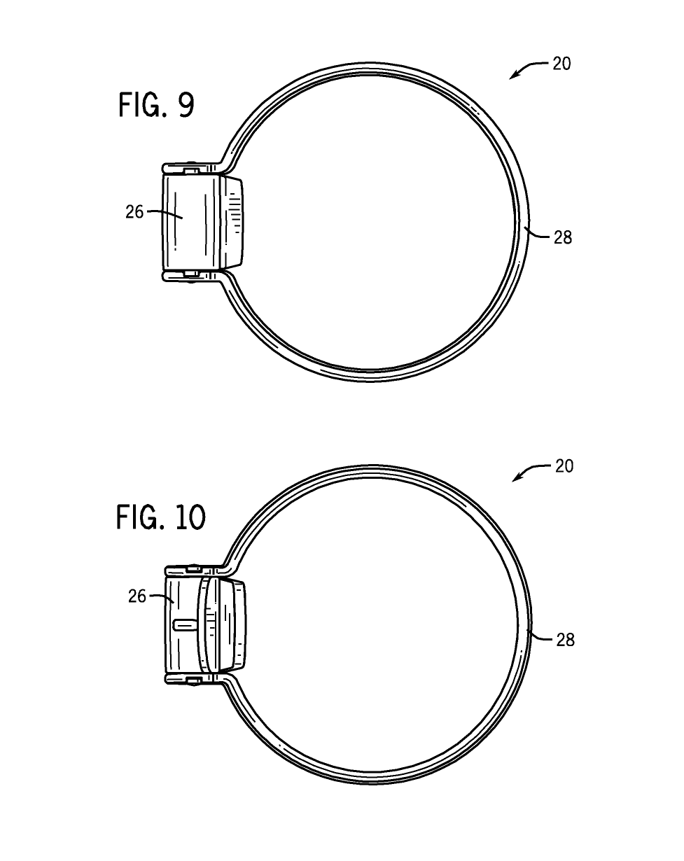

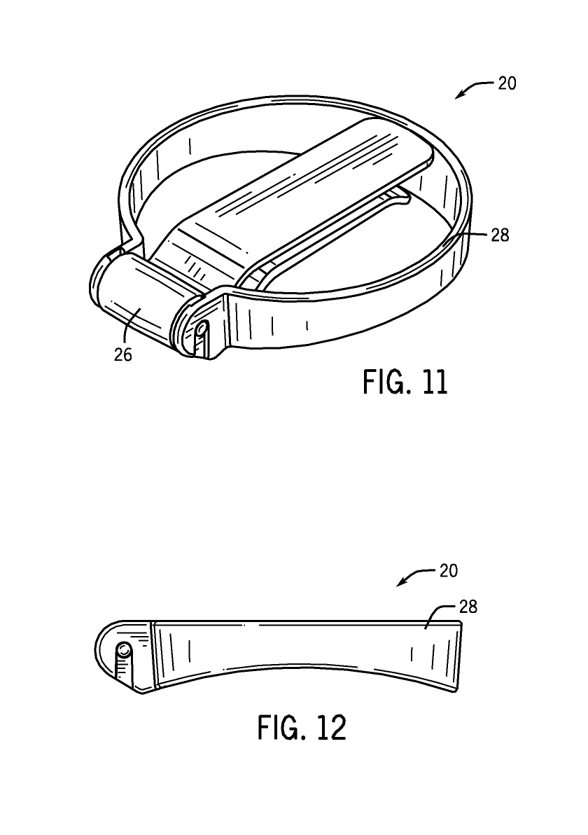

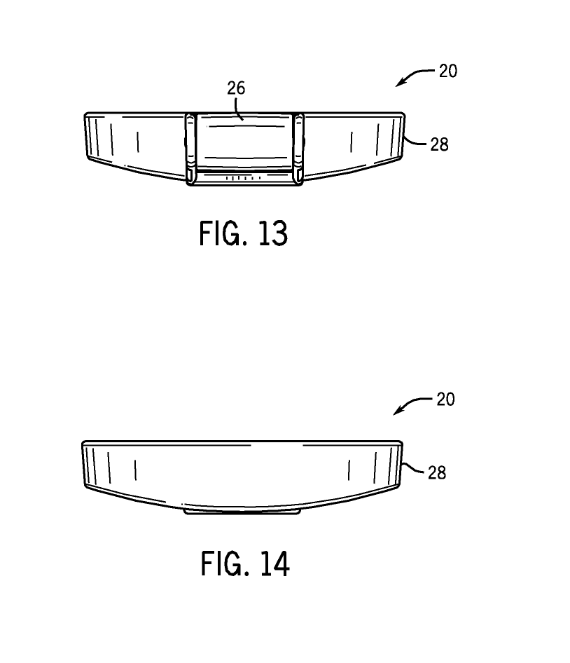

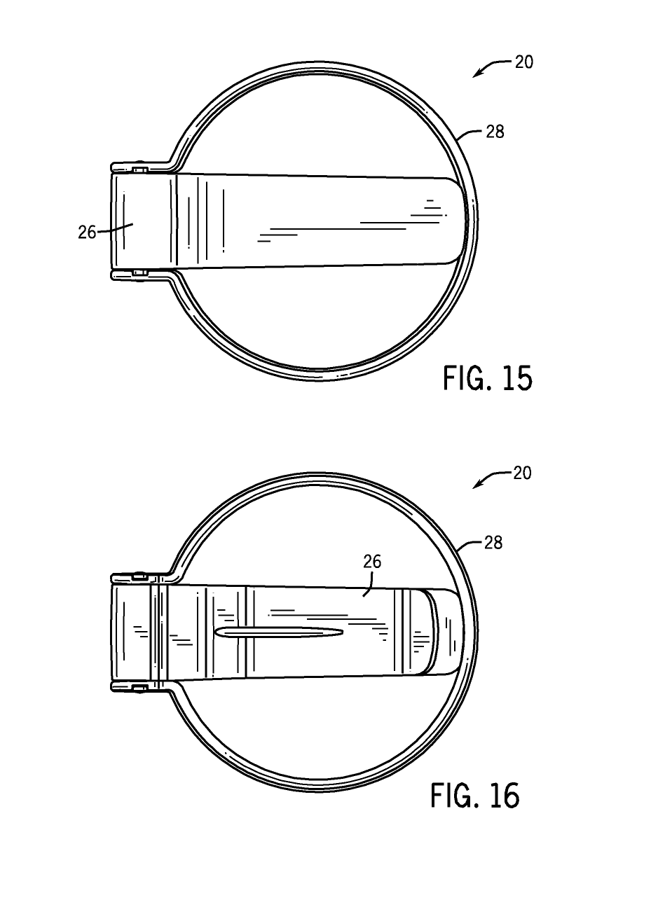

With reference to FIG. 6, the inner surface 88 of the first flange 84 is spaced apart from the inner surface 102 of the second flange 86 a distance D1 proximate their axially upper peripheries at which location the distance between the flanges 84 and 86 is greatest in the illustrated embodiment.

With further reference to FIG. 6, the rounded portion 74 of the coupling portion 71 of the clip 26 extends from a first end 118 to a second end 120 a width W1. In one embodiment, the width W1 is less than the distance D1.

The hub 77 includes a first portion 122 that extends past the first end 118 of the rounded portion 74. The hub 77 also includes a second portion 124 that extends past the second end 120 of the rounded portion 74. In one embodiment, the width W2 of the hub 77 from the outer periphery of the first portion 122 to the outer periphery of the second portion 124 is greater than the distance D1. Additionally, the width W2 of the hub 77 is greater than the distance D3 between the wall of the track 92 and the wall of the track 104 (see FIGS. 4 and 5).

In one embodiment, the width W2 of the hub 77 is substantially the same as the distance D4 between the rounded recessed portion 98 and the rounded recessed portion 110 (see FIGS. 4 and 5).

With reference to FIGS. 4-6, to couple the clip 26 to the ring portion 28, the first and second portions 122 and 124 of the hub 77 are placed in tracks 92 and 104 respectively. In doing so, the flanges 84 and 86 are deflected outwardly relative to one another proximate the location of the first and second portions 122 and 124. The clip 26 is displaced downwardly relative to the ring portion 28, with the first and second portions 122 and 124 moving downwardly towards the rounded recessed portions 98 and 110. When the first and second portions 122 and 124 are located in the rounded recessed portions 98 and 110, the flanges 84 and 86 are allowed to flex back inwardly to their original configuration relative to one another, with the hub 77 retained between the flanges 84 and 86 with the first and second portions 122 and 124 located proximate and at least partially located in the rounded recess portions 98 and 110 respectively. In this configuration, the clip 26 is pivotally displaceable about an axis through the hub 77 and through rounded recess portions 98 and 110 relative to the ring portion 28 between the first configuration and the second configuration.

In one embodiment, at least one of the legs 36 and 38 of the clip 26 is substantially flexible and displaceable relative to the other of the legs of the clip. In another embodiment, the legs 36 and 38 of the clip 26 are not flexible and are not displaceable relative to one another.

In one embodiment, the clip 26 may be actuated between a first configuration in which there is no gap 44 and the legs 36 and 38 are in contact distal from the hinge portion 34 and a second configuration in which there is a gap 44 between the legs 36 and 38 distal from the hinge portion 34 to allow insertion of a support through the gap 44 and into the slot 40. In another embodiment, once a support has been inserted into the slot 40, the legs 36 and 38 may be allowed to displace back towards the first configuration trapping the support between them.

In one embodiment the hub 77 extends from the peripheral edge of the first portion 122 to the peripheral edge of the second portion 124. In another embodiment, the hub 77 includes two distinct portions, one including the first portion 122 and one including the second portion 124 with gap between these two portions.

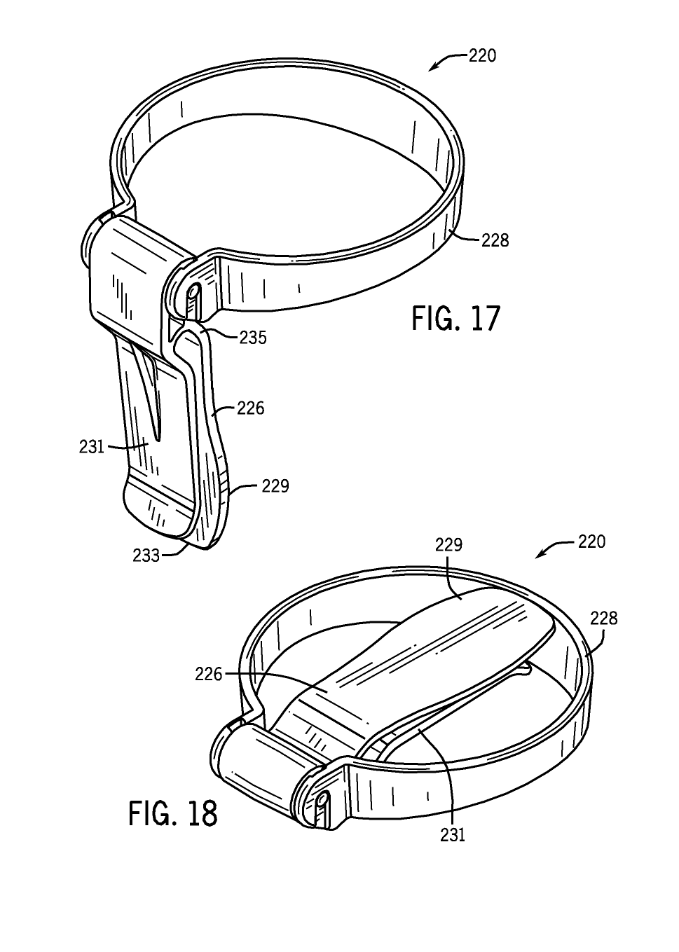

With reference to FIG. 17, another embodiment of a holder 220 is illustrated in a first configuration. In one embodiment, the holder 220 includes an engagement portion configured to couple to an object such as a pocket to support the holder 220, illustrated in FIG. 2 as clip 226, and a holding portion configured to hold a container, illustrated in FIG. 2 as ring portion 228. The holder 220 is configured to be actuated between a first configuration, as shown in FIG. 17, with the ring portion 228 configured to receive and support an object to be held and the clip 226 configured to receive a portion of an object on which the holder 220 is supported, and a second configuration, as shown in FIG. 18. In one embodiment, the holder 220 includes many features similar to the holder 20; therefore, differences between the holder 220 and the holder 20 are the focus of the description below.

With further reference to FIG. 17, in one embodiment, the clip 226 includes a first leg 229 and a second leg 231 spaced apart from the first leg 229 and defining a channel therebetween configured to receive an object (e.g., pocket, etc.) upon which the holder 220 is supported.

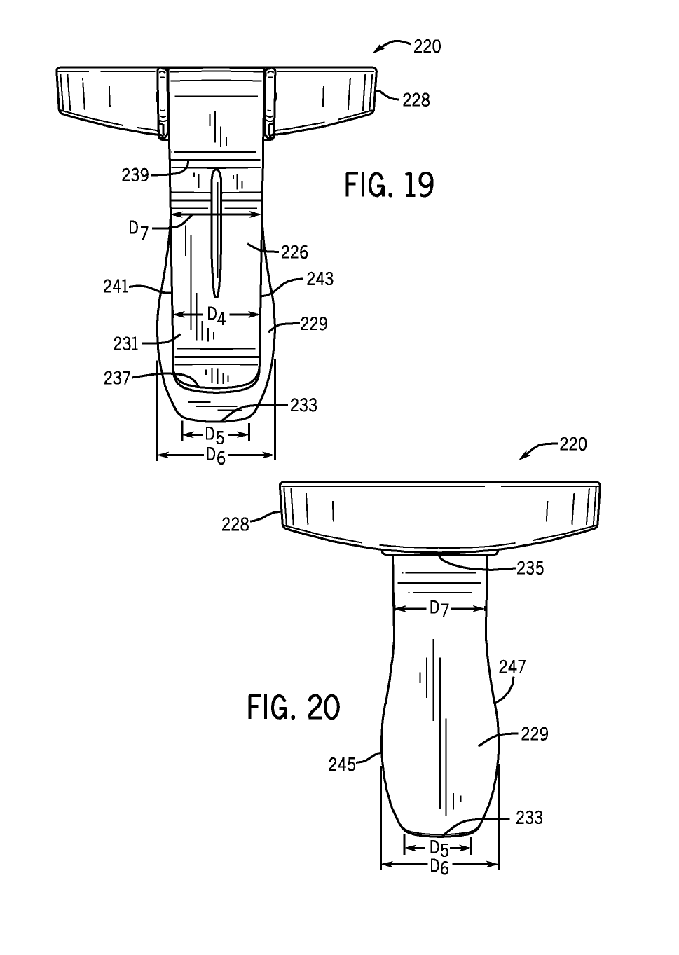

With reference to FIGS. 19 and 20, the first leg 229 extends from a first lower end 233 to a second upper end 235. The second leg 231 extends from a first lower end 237 to a second upper end 239. In one embodiment, the first leg 229 extends past the second leg 231, with the first lower end 233 of the first leg 229 being lower than the first lower end 237 of the second leg 231.

With reference to FIG. 19, the second leg 231 extends a distance D4 from a first side 241 to a second side 243. In one embodiment, the distance D4 is generally the same along the length of the second leg 231 from the first lower end 237 to the second upper end 239. In another embodiment, the distance D4 that the leg extends from the first side 241 to the second side 243 gradually increases from a minimum proximate the first lower end 237 to a maximum proximate the second upper end 239.

With reference to FIG. 20, in one embodiment, the first leg 229 extends from a first side 245 to a second side 247. Proximate the first end 233, the first leg 229 extends a distance D5 between the first side 245 and the second side 247. The distance that the first leg 229 extends between the first side 245 and the second side 247 increases to a maximum D6 between the first lower end 233 and the second upper end 235. The distance that first leg 229 extends between the first side 245 and the second side 247 decreases to a distance D7 proximate the second upper end 235. In one embodiment, the distance D7 is approximately equal to the distance D4 of the second leg 231. In one embodiment, the distance D6 is greater than the distance D1.

Embodiments of holders may be coupled to supports for supporting the holder and a container supported by the holder. In one embodiment, a holder may be coupled various other types of supports, e.g., wires, sheets, edges, etc. In other embodiments, a holder may be coupled to any suitable to be received in the slot and to support the holder.

In one embodiment, embodiments of holder may be formed from a suitable type of plastic (e.g., polyethylene, polypropylene, polystyrene, polyvinyl chloride, PTFE, nylon, PET, HDPE, polylactic acid (PLA), etc.) In other embodiments, embodiments of holders may be formed from various suitable metals, alloys, etc. In other embodiments, holders may be formed from other suitable materials.

In one embodiment, a holder may be formed by molding, e.g., injection molding, other suitable types of molding, etc. In another embodiment, a holder may be formed by machining, e.g., computer numerical control, etc., from, e.g., metal or any other suitable material. In another embodiment, a holder may be formed by casting, e.g., metal casting, etc.

In another embodiment, a holder may be formed by 3D printing (e.g., selective laser sintering, direct metal laser sintering, fused deposition modeling, stereolithography, laminated object manufacturing, electron beam melting, power bed and inkjet head 3D printing, etc.). In another embodiment, a holder may be molded. In another embodiment, a holder may be formed by any other suitable method.

In one embodiment, the rounded recessed portions 98 and 110 are apertures extending through the flanges 84 and 86, and the first and second portions 122 and 124 of the hub 77 are configured to be located in these apertures. In one embodiment, the hub 77 extends a width as wide as the width between the outer surfaces 90 and 102 of the flanges 84 and 86. In another embodiment, the hub extends a width wider than the width between the outer surfaces 90 and 102 of the flanges 84 and 86.

In one embodiment, a holder is formed in two pieces with coupling portions configured to couple together for pivotal displacement of the two pieces relative to one another. In another embodiment, a holder includes a third separate hinge piece configured to couple the two pieces to one another for pivotal displacement relative to one another. In another embodiment, the hinge is integrally formed with one or both of the pieces. In another embodiment, a holder is formed as a single, unitary piece. In other embodiments, a holder may be formed in any suitable number of pieces in by any suitable method.

Unless the meaning is clearly to the contrary, all ranges set forth herein are deemed to be inclusive of the endpoints.

In various embodiments, holders may be configured to support any suitable type of container. In one embodiment, the container has a tapered or angled sidewall. Thus, the container may enter the aperture and a portion of the sidewall with a greater diameter may contact the inner surface of the ring portion, allowing the holder to retain the container in the aperture and support the container.

In one embodiment, the diameter of the ring portion is variable to allow the holder to support containers of various dimensions. In one embodiment the ring portion is elastically displaceable to allow the ring portion to retain containers of various dimensions in the aperture.

In one embodiment, the ring portion is configured to receive into the aperture and support containers having a sidewall with a diameter that decreases from top to bottom. In another embodiment, the ring portion is configured to receive a container having a sidewall having any suitable shape, size, and dimension.

In one embodiment, the bar 112 is configured to flex proximate a middle portion between the first end 114 and the second end 116 radially inwardly toward the aperture 32 when a container is retained in the aperture 32.

In the illustrated embodiments, the ring portion is illustrated as a generally round ring portion with a gap proximate the flanges. In another embodiment, the ring portion does not include a gap proximate the flanges. In other embodiments, the ring portion may be any suitable shape (oval, triangle, quadrilateral, heptagon, hexagon, septagon, octagon, other regular or irregular polygon or non-polygon, etc.)

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only.

Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. Other substitutions, modifications, changes and omissions may also be made in the design, operating conditions and arrangement of the various exemplary embodiments without departing from the scope of the present invention. While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

What is claimed is:

1. A holder comprising:
a holding portion including a ring portion, the ring portion including an inner surface defining an aperture;
a hinge portion; and
an engagement portion pivotably displaceable relative to the holding portion between a first configuration in which the holder is configured to receive a first object, the inner surface being configured to engage the first object received within the aperture and a second configuration, the engagement portion extending between a first end proximate the hinge portion and a second end distal from the hinge portion, the engagement portion defining a slot for receiving a second object in an environment by which the holder is configured to be supported, the engagement portion defining a gap distal from the hinge portion through which the second object is configured to be received into the aperture.

2. The holder of claim 1, wherein the engagement portion is located within the aperture in the second configuration.

3. The holder of claim 1, wherein the engagement portion extends generally downwardly from the holding portion in the first configuration.

4. The holder of claim 1, wherein the hinge portion includes a first flange and a second flange spaced apart from the first flange, the first and second flanges extending away from the ring portion.

5. The holder of claim 4, wherein the first and second flanges are generally parallel, the first flange including a first inner surface including a first track, the second flange including a second inner surface including a second track, the first and second tracks extending generally parallel with one another, the first track terminating at a first depression, the second track terminating at a second depression.

6. The holder of claim 5, wherein the engagement portion includes a first side and a second side opposite the first side, the first side including a first projection extending therefrom, the first projection configured to engage the first depression, the second side including a second projection extending in the opposite direction of the first projection, the second projection configured to engage the second depression; wherein, the engagement portion is pivotally displaceable relative to the ring portion about an axis between the first projection and the second projection.

7. The holder of claim 4, wherein in the first configuration the engagement portion is inhibited from pivotal displacement relative to the holding portion in one direction.

8. The holder of claim 7, wherein the ring portion defines a gap proximate the first and second flanges; and
wherein the holder includes a stop spanning the gap of the ring portion.

9. The holder of claim 1, wherein the ring portion is configured above the portion of the second object in the environment by which the holder is configured to be supported located within the slot when the object is disposed in the slot and supporting the holder.

10. The holder of claim 1, wherein the ring portion is generally circularly-shaped.

11. The holder of claim 1, wherein the first object is generally round; and wherein the portion of the second object located within the slot is generally planar.

12. A holder comprising:
a holding portion including a ring portion configured to engage and support a container;
an engagement portion pivotally coupled to the holding portion, the engagement portion pivotable between a first configuration wherein the holding portion is configured to support the container and a second configuration;
wherein the engagement portion extends generally downwardly away from the ring portion in the first configuration, and
wherein the engagement portion is inhibited from pivotal movement relative to the ring in one direction in the first configuration.

13. The holder of claim 12, wherein the ring portion defines an aperture; and wherein the engagement portion is located within the aperture in the second configuration.

14. The holder of claim 12, further comprising a hinge pivotally coupling the engagement portion to the holding portion.

15. The holder of claim 12, further comprising a hinge portion including a pair of flanges extending from the ring portion and a pair of projections projecting from the engagement portion, the projections and flanges configured to couple the engagement portion to the holding portion.

16. The holder of claim 15, wherein the engagement portion includes a clip including a first leg and a second leg, the first leg and the second leg being joined proximate the hinge portion and defining a gap between the legs distal from the hinge portion configured to receive an object to support the holder.

17. A method of using a holder, the holder including a holding portion including a ring portion configured to engage and support a container, an engagement portion pivotally coupled to the holding portion, the engagement portion pivotable between a first configuration wherein the holding portion is configured to support a container and a second configuration, and the engagement portion extending generally downwardly away from the ring portion in the first configuration, the method comprising the steps of:
pivotally displacing the engagement portion to the first configuration;
coupling the engagement portion to a support;
locating a container in the holding portion;
removing the container from the holding portion;
uncoupling the engagement portion from the support;
pivotally displacing the engagement portion to the second configuration.

18. The method of claim 17, wherein the ring portion defines an aperture and wherein the step of pivotally displacing the engagement portion to the second configuration includes locating the engagement portion with the aperture defined by the ring portion.

19. The method of claim 17, wherein the container is a beverage container including a sidewall having a non-cylindrical portion.

20. The method of claim 17, wherein the support is a pocket.
